(19) United States
(12) Patent Application Publication
(10) Pub. No.: US 2020/0238482 A1
(43) Pub. Date: Jul. 30, 2020

(54) ENHANCED STICK FIT BIT DESIGN

(71) Applicant: Acument Intellectual Properties, LLC, Sterling Heights, MI (US)

(72) Inventor: David C. Goss, Rockford, IL (US)

(21) Appl. No.: 16/750,960

(22) Filed: Jan. 23, 2020

Related U.S. Application Data
(60) Provisional application No. 62/796,440, filed on Jan. 24, 2019.

(51) Int. Cl. B25B 15/00; F16B 23/00; B25B 23/02

(52) U.S. Cl. CPC B25B 15/005; B25B 23/02; F16B 23/0038; F16B 23/003

(57) ABSTRACT

A bit cutter is used to cut a bit, where the bit cutter matches the configuration of a recess in a corresponding fastener. The resulting bit contacts the top of the recess of a fastener, along a plurality of lines of contact. The fact that the contact is along a plurality of lines, as opposed to mere points, provides for improved frictional adhesion or “stick fit” between the bit and the fastener.

### RELATED APPLICATION (PRIORITY CLAIM)

This application claims the benefit of U.S. Provisional Application Ser. No. 62/796,440, filed on Jan. 24, 2019, and is hereby incorporated herein by reference in its entirety.

### BACKGROUND

In the fastener industry, the term “stick fit” is used to describe a feature where a fastener and a corresponding driver (i.e., bit) are collectively configured such that there is frictional adhesion between the driver and the fastener. As a result, the fastener can be releasably engaged on the driver to enable manipulation of the driver and fastener, together as a unit, for installation of the fastener in hard to reach places. Despite the frictional adhesion, once the fastener is installed, the driver can be readily disengaged from the fastener.

Many existing fastening systems rely upon multiple non-continuous contact points (as opposed to lines of contact) between a bit and a recess in the head of a fastener, typically at the top of the recess.

The most common method to make a multi-lobular fastening system (i.e., bit drive configuration) such as is disclosed in the '667 patent, is to use individual lobe and flute cutters to individually cut each lobe and flute, respectively. Typically, the cutter profiles match the bit drive configuration, while the bit drive configuration differs from the corresponding recess configuration usually in the form of a dimensional parallel offset.

In situations where a “stick fit” is desired, typically the cutters' profiles are modified to ensure multiple non-continuous contact points (see FIGS. 1 and 2, wherein the contact points between the bit 12 and recess 14 are indicated with reference numeral 10, and clearance between centerlines of the flute and lobe is indicated with reference numeral 11 (despite the fact that the clearance is difficult to discern visually in FIG. 1)). Sometimes the points of contact that result do not provide sufficient surface contact area to ensure consistent frictional adhesion or “stick fit,” especially when it comes to large, heavy fasteners because the weight of the fastener tends to make the fastener fall away from the bit. Similarly, achieving a proper stick fit with regard to very small or miniature fasteners is often challenging due to the fact that such fasteners have very shallow recesses that cannot be deeply penetrated.

### SUMMARY

An embodiment of the present invention provides for enhanced stick fit engagement between a fastener and bit.

Another embodiment of the present invention provides for lines of contact between a bit and a recess in the head of a fastener, as opposed to mere points of contact.

Still yet another embodiment of the present invention provides a fastening system that provides adequate surface area contact between a bit and a recess in the head of a fastener, such that a satisfactory stick fit is achievable with regard to both larger, heavy fasteners and smaller, miniature fasteners.

Briefly, an embodiment of the present invention provides for the use of a bit cutter which matches the configuration of a recess in a corresponding fastener. The bit cutter profile progresses along a taper, and the bit which is ultimately formed is configured to contact the top of the recess along a plurality of lines of contact (i.e., along both the lobes and the flutes of the recess of the fastener). The fact that a plurality of lines of contact result, as opposed to mere points of contact, provides for improved frictional adhesion or “stick fit” between the bit and the fastener, compared to prior art configurations that provide only points of contact between the two components. Providing lines of contact increases the odds that a satisfactory stick fit can be achieved despite the fastener either being large and heavy or small and miniature, and the lines of contact provide for enhanced stick bit engagement regardless of the size of the fastener.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 shows a bit engaged with a recess, wherein the engagement provides points of contact in accordance with prior art;

FIG. 2 is a cross-sectional view of the engagement of the bit as recess shown in FIG. 1;

FIG. 3 shows a recess provided in the head of a fastener;

FIG. 4 shows a bit;

FIG. 5 shows the bit of FIG. 4 engaged with the recess of FIG. 3, wherein the engagement provides lines of contact in accordance with an embodiment of the present invention;

FIG. 6 is a flowchart showing a method of making the bit shown in FIG. 4, wherein the method is in accordance with an embodiment of the present invention;

FIG. 7 shows a cutter which can be used to form the bit shown in FIG. 4;

FIG. 8 shows the profile of the cutter shown in FIG. 7, wherein the profile corresponds to the recess shown in FIG. 3 in accordance with an embodiment of the present invention;

FIGS. 9-11 show some dimensions relating to the recess shown in FIG. 3;

FIG. 12 shows a cutter being used to form a 5-lobed tamper-resistant stick fit bit;

FIG. 13 shows the bit that was formed using the cutter shown in FIG. 12;

FIG. 14 shows a cutter being used to form a miniature, tamper-resistant bit;

FIG. 15 shows the bit that was formed using the cutter shown in FIG. 14; and

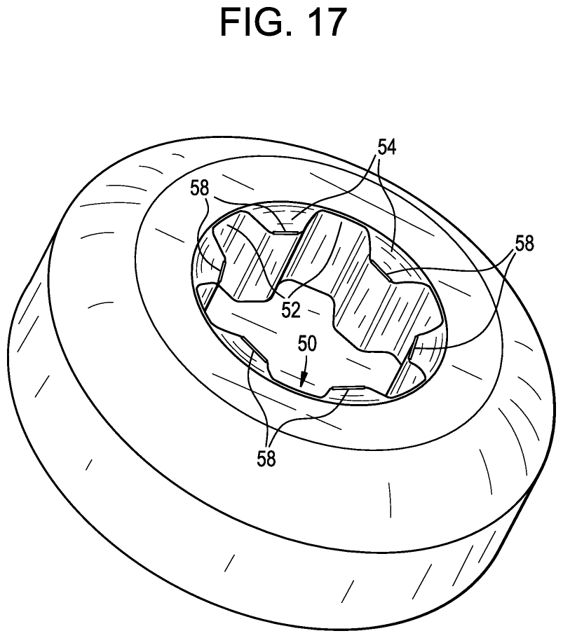

FIGS. 16-18 show an embodiment of the present invention, wherein the embodiment effectively relates to the fastening system disclosed in U.S. Pat. No. 9,562,557.

### DESCRIPTION

While this invention may be susceptible to embodiment in different forms, there are shown in the drawings and will be described herein in detail, specific embodiments with the understanding that the present disclosure is to be considered an exemplification of the principles of the invention, and is not intended to limit the invention to that as illustrated.

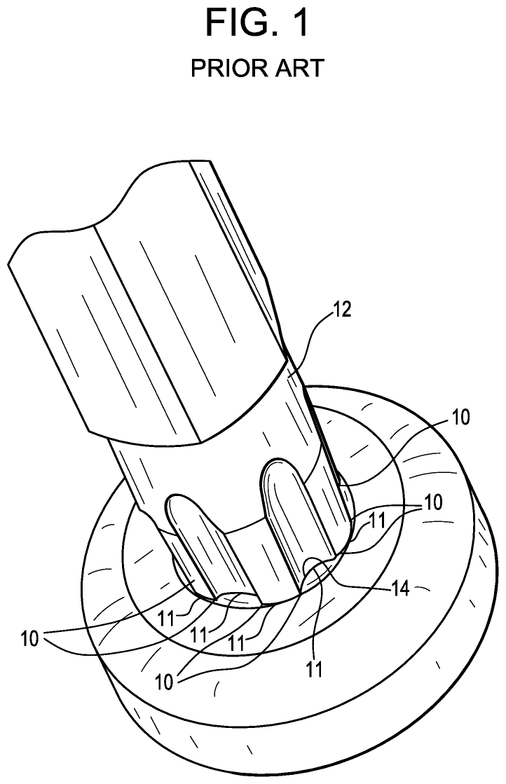

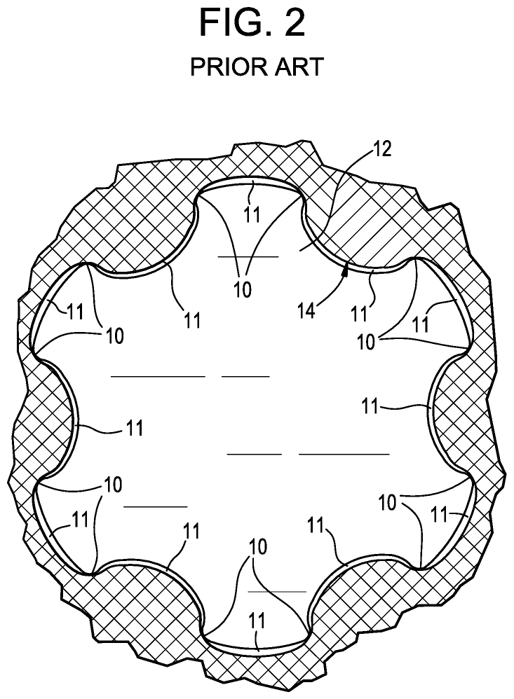

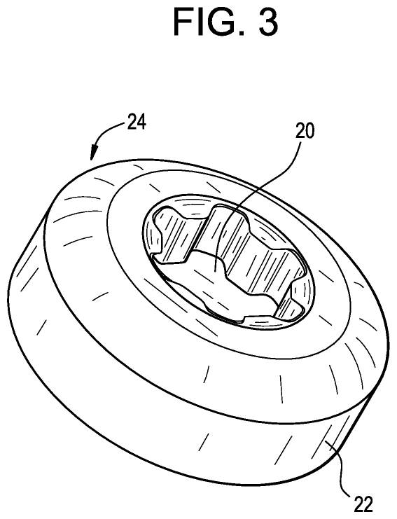

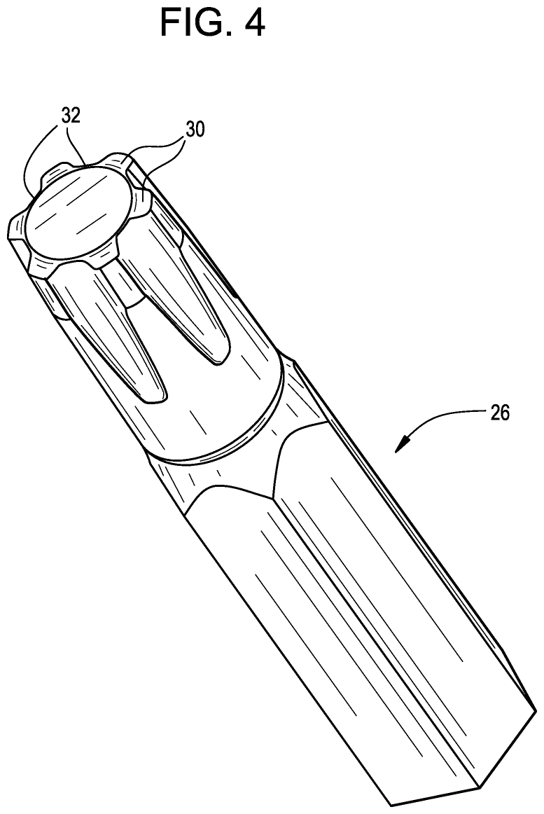

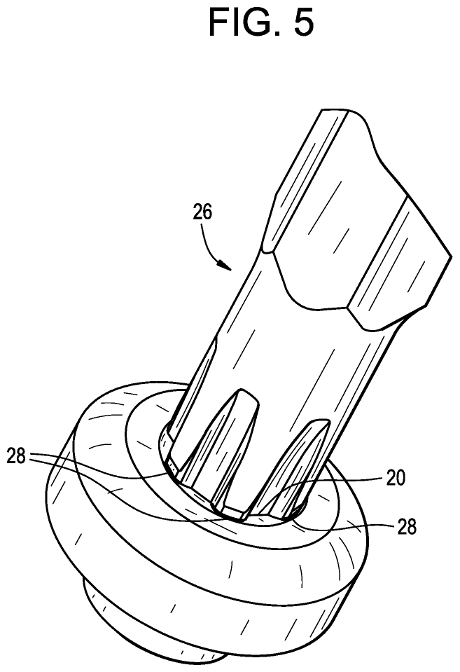

FIG. 3 shows a recess 20 provided in the head 22 of a fastener 24, FIG. 4 shows a bit 26, and FIG. 5 shows the bit 26 of FIG. 4 engaged with the recess 20 of FIG. 3, wherein the engagement provides lines of contact (indicated with reference numeral 28) in accordance with an embodiment of the present invention, as opposed to mere points of contact 10, as shown in FIGS. 1 and 2 and provided by prior art. Regarding the lines of contact as discussed herein, each line of contact can be any curvilinear structure, and is not meant to be limited to a single straight or curved geometry.

The fact that a plurality of lines of contact result (as shown in FIG. 5), as opposed to mere points of contact (as shown in FIGS. 1 and 2), provides for improved frictional adhesion or “stick fit” between the bit and the fastener, compared to prior art configurations that provide only points of contact between the two components. Providing lines of contact enables achieving a satisfactory stick fit despite the fastener either being large and heavy (such as greater than 5/16 inch (M8)) or small and miniature (such as less than #2-0.086 inch (M2)), and the lines of contact provide for enhanced stick bit engagement regardless of the size of the fastener. As shown in FIG. 5, preferably the lines of contact extend not only across the A dimension (i.e., the ends of the lobes), but across and along the side of each lobe going toward the adjacent flutes.

An embodiment of the present invention provides a method of forming a bit 26 such as shown in FIG. 4, wherein the bit 26 is configured to contact the recess 20 along lines of contact 28 as shown in FIG. 5, as opposed to points of contact 10 as shown in FIGS. 1 and 2.

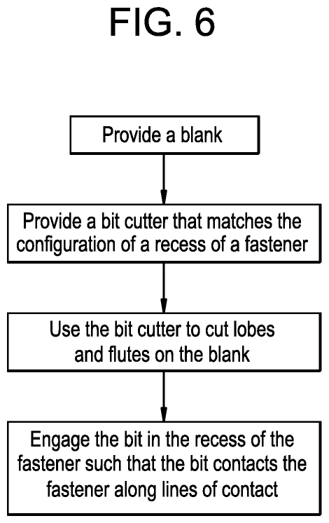

As shown in the flowchart in FIG. 6, first a blank is provided, and then a bit cutter is used to cut lobes 30 and flutes 32 on the blank in order to form the bit 26 shown in FIG. 4.

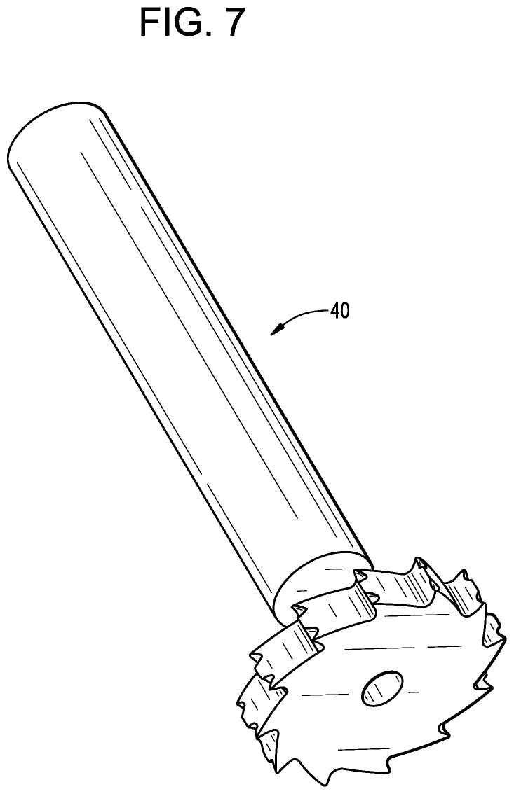

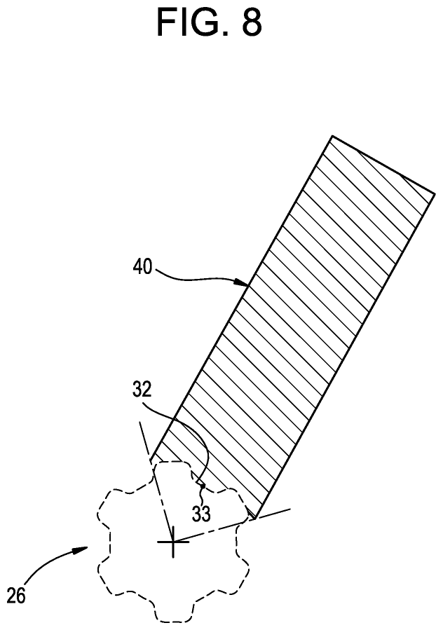

FIG. 7 shows a bit cutter 40 which can be used in connection with the method shown in FIG. 6. The bit cutter 40 is preferably used to cut along a taper and along a centerline 33 of a flute 32 (see FIG. 8), and the process is repeated for each flute.

As shown in FIG. 8, the profile of the cutter 40 matches the profile of the recess 20 of the fastener 24 (see FIG. 3) with which the bit 26 is ultimately configured to engage. As a result, when the bit 26 as shown in FIG. 4 is subsequently engaged in the recess 20 of the fastener 24 shown in FIG. 3, the bit 26 contacts the fastener 24 proximate the top of the recess 20, along lines of contact 28 as shown in FIG. 5, as opposed to mere points of contact 10 as shown in FIGS. 1 and 2.

While a cutter 40 is used to make the bit 26 (see FIG. 4), a punch pin is used to punch a recess in the head of a fastener (see FIG. 3), both of which will be described in more detail hereinbelow.

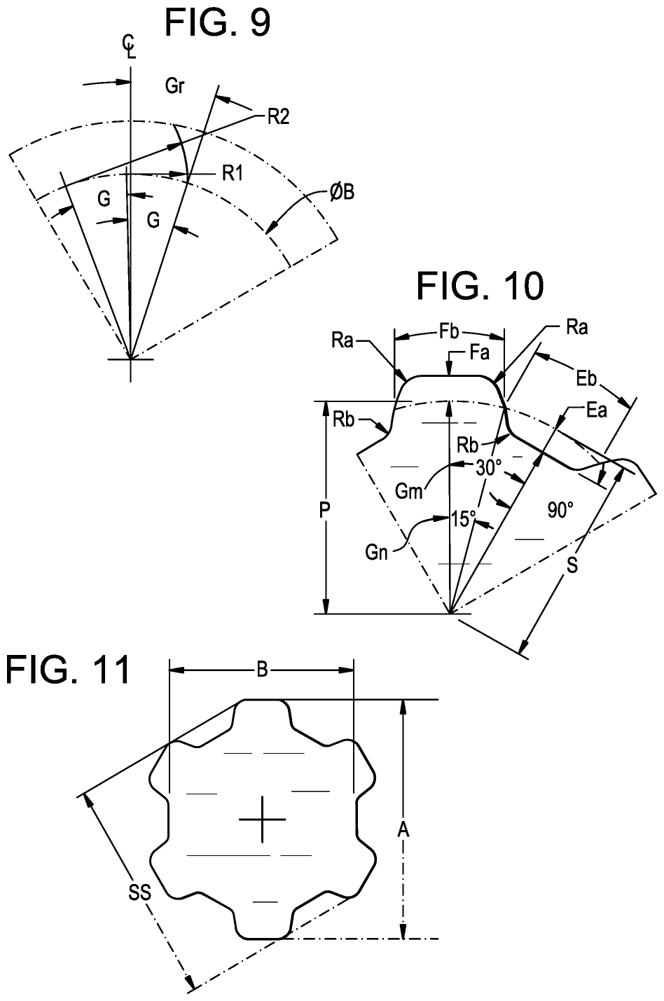

FIGS. 9-11 indicate some dimensions which can effectively relate to a profile of any of the bit, cutter, recess, punch pin, etc. To the extent any of the following recess parameters are used in any of FIGS. 9-11, they mean the following: A relates to the recess configuration circumscribed diameter; B relates to the recess configuration inscribed diameter; Fa relates to the recess lobe height (Fa) from recess involute pitch radius (P) to recess configuration circumscribed diameter; Fb relates to the recess configuration lobe arc width (Fb) at recess involute pitch radius (P); Ea relates to the recess flute depth (Ea) from recess involute pitch radius (P) to recess configuration inscribed diameter (B); Eb relates to the recess configuration flute arc width (Eb) at recess involute pitch radius (P); P relates to the recess involute pitch radius (P) where the nominal recess configuration lobe arc width (Fb) is equal to the recess configuration flute arc width (Eb); S is equal to P; Gn relates to the recess involute rotation angle (Gn) from the lobe centerline at recess involute pitch radius (P), wherein Gn=90/N where N=Number of Lobes, e.g. Gn=15 degrees for N=6; Gm relates to the angle between the recess lobe centerline and the recess flute centerline (Gm=2Gn); SS relates to the across lobe dimension; Gr relates to the recess involute total rotation angle from the centerline of the nominal recess lobe to beginning of recess first polygon segment; G relates to the sweep angle of the recess polygon segments; the first polygon segment is the beginning of the recess the first polygon segment starts at the intersection of recess involute total rotation angle (Gr) and recess configuration inscribed diameter (B); the second polygon segment relates to the beginning of the recess second polygon segment is at the vertex of the recess first and second polygon segments; R1 relates to the recess first polygon involute radius arc (R1) starts at the beginning of the recess 1st polygon segment with a center at the vertex of the recess 1st and 2nd polygon segments. (note: recess R1=bit R1); R2 relates to the recess second polygon involute radius arc (R2) starts at the end of recess R1 with a center at the end of recess 2nd polygon segment. (note: recess R2=bit R2), wherein the center of the recess first polygon involute radius arc (R1) is at the beginning of recess second polygon segment, and the center of the recess second polygon involute radius arc (R2) is at the end of the recess second polygon segment; Ra relates to the recess corner blend radius between an arc segment of the recess configuration circumscribed diameter (A) and the recess second polygon involute radius arc (R2); and Rb relates to the recess fillet blend radius between the recess first polygon involute radius arc (R1) and the recess configuration flute-flat which is centered at the recess configuration inscribed diameter (B).

To the extent any of the following bit parameters are used in any of FIGS. 9-11, they mean the following: Ar relates to the recess configuration circumscribed diameter; Br relates to the recess configuration inscribed diameter; A relates to the bit configuration circumscribed diameter; B relates to the bit configuration inscribed diameter; Fa relates to the bit lobe height (Fa) from the recess involute pitch radius (P) to the bit configuration circumscribed diameter (A); Fb relates to the bit configuration lobe arc width (Fb) at the recess involute pitch radius (P); Ea relates to the bit flute depth (Ea) from the recess involute pitch radius (P) to the bit configuration inscribed diameter (B); Eb relates to the bit configuration flute arc width (Eb) at the recess involute pitch radius (P); P relates to the recess involute pitch radius; S is equal to P, Gm relates to the angle between the bit lobe centerline and bit flute centerline (Gm=2Gn); SS is the across lobe dimension; Gb relates to the bit involute total rotation angle from the centerline of the nominal bit lobe to the beginning of recess first polygon segment; Gb relates to the bit involute total rotation angle from the centerline of the nominal bit lobe to the beginning of recess first polygon segment; G relates to the sweep angle of the bit polygon segments; wherein the beginning of the first polygon segment of the bit starts at the intersection of the bit involute total rotation angle (Gb) and the bit configuration inscribed diameter (B), and wherein the beginning of the second polygon segment of the bit starts at the vertex of the bit first and second polygon segments; R1 relates to the bit first polygon involute radius arc (R1) which starts at the beginning of the bit first polygon segment with a center at the vertex of the bit first and second polygon segments (note: recess R1=bit R1), wherein the center of the bit first polygon involute radius arc (R1) is at the beginning of bit second polygon segment, and the center of the bit second polygon involute radius arc (R2) is at the end of the bit second polygon segment; Ra relates to the bit corner blend radius between an arc segment of the bit configuration circumscribed diameter (A) and the bit second polygon involute radius arc (R2); and Rb relates to the bit fillet blend radius between the bit 1st polygon involute radius arc (R1) and the bit configuration flute-flat which is centered at the bit configuration inscribed diameter (B).

In an embodiment of the invention, the drive system geometries, including the bit and recess geometries are based upon the creation of an involute using a convex polygon where all vertices are pointing outward.

Regarding the recess 20 shown in FIG. 3, in one example of an amendment of the present invention, assuming the A dimension is approximately 0.10000 inches, the B dimension is preferably 0.07700 inches, the Fa dimension is 0.00575 inches, the Fb dimension is 0.2317 inches, the Ea dimension is 0.00575 inches, the Eb dimension is 0.02317 inches, the S dimension is 0.04425 inches, and the P dimension is 0.04425 inches. Another example would provide that the A dimension is approximately 0.05000 inches, the B dimension is 0.03550 inches, the Fa dimension is 0.00363 inches, the Fb dimension is 0.01119 inches, the Ea dimension is 0.00363 inches, the Eb dimension is 0.01119 inches, the S dimension is 0.02138 inches, and the P dimension is 0.02138 inches.

While exact dimensions are recited above, obviously tolerances come into play with regard to not only the components of the drive system (i.e., the bit 26 and the corresponding recess 20 in the head 24 of the fastener 26), but also the components which are used to make those components (i.e., the cutter 40 which is used to form the drive profile on the bit, and the punch pin which is used to form the recess 20 in the head 24 of the fastener 26). As such, all dimensions range between a minimum and a maximum acceptable value (i.e., for example, the A dimension preferably has a value greater than or equal to Aₘᵢₙ, and less than or equal to Aₘₐₓ, and so on with the B dimension, etc.).

Preferably, the cutter profile dimensions A and B are the same as the punch pin dimensions A and B, with regard to the minimum both A and B should be within an acceptable tolerance (i.e., Aₘᵢₙ and Bₘᵢₙ, respectively). In other words, the A dimension of the punch pin is preferably at least as large as the A dimension of the cutter profile which is used to form the bit. Likewise, the B dimension of the punch pin is preferably at least as large as the B dimension of the cutter profile which is used to form the bit. In general, the punch pin configuration dimensions are preferably sized such that the recess configuration, after heading, are within the target recess configuration dimensions.

With regard to whether a given bit has acceptable dimensions to satisfy the goals of the present invention (i.e., generating lines of contact with a corresponding recess as opposed to points of contact), preferably a gage is used wherein the bit profile is inserted into the gage for testing. Preferably, the A and B dimensions of the gage are the same as the cutter profile A and B dimensions.

With regard to the bit, preferably the cutter is used to make the profile on the bit such that the cross-sectional configuration diameter of the bit changes along the tapered cutter path, producing the full stick fit bit configuration body.

Preferably, the nominal recess configuration dimensions are the same at the minimum punch pin configuration dimensions and thus is same as the stick fit bit cutter profile configuration dimensions. In general, the intention is for the punch pin configuration dimensions to result in “as headed” recess dimensions, within tolerance. This results in a recess configuration at the top of the recess which is a near complete alignment fit with the stick fit bit configuration.

Preferably, the cutter profile is effectively excised from the punch pin minimum configuration whose centerline coincides with the configuration flute centerline. The change in stick fit cross section configuration as the cutter moves along the flute centerline produces the full stick fit bit configuration body.

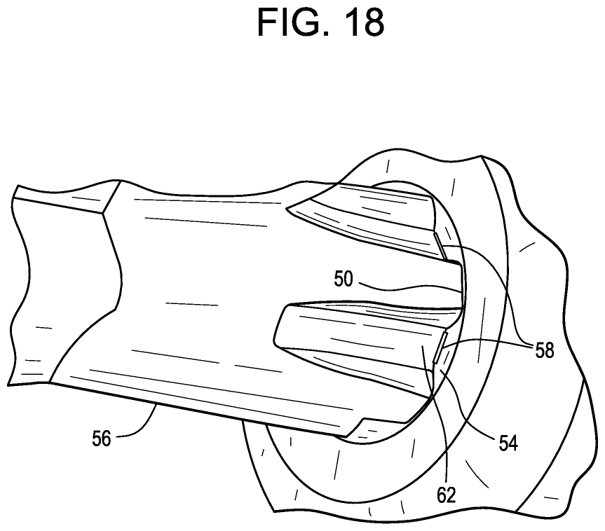

FIGS. 16-18 show an embodiment of the present invention, wherein the embodiment effectively relates to the fastening system disclosed in U.S. Pat. No. 9,562,557, which is hereby incorporated herein by reference.

As disclosed in the '557 patent, a fastening system is provided wherein a recess in a fastener is provided, wherein the recess has deeper flutes than it does lobes (i.e., the recess has an enlarged A dimension). As a result, there is extra room for a coating, such as a Zinc coating, to settle in the flutes. This results in a better fit being subsequently achieved between the recess and a corresponding bit.

FIGS. 16-18 are consistent, and show an embodiment where a recess 50 was provided as having deeper flutes 54 than it does lobes 52 (and then a coating, such as Zinc, was applied). As shown, because the bit 56 was formed in accordance with the present invention, lines of contact 58 are provided between the flutes 60 of the bit 56 and the lobes 52 of the recess 50 (i.e., along the B dimension). FIG. 16 shows the bit 56 engaged with the recess 50, FIG. 17 shows the recess 50 after the bit 56 has been removed, and identifying with reference numerals 58 where the lines of contact were, and FIG. 18 identifies the lines of contact 58 across the lobes 52 of the recess 50 and the flutes 60 of the bit 56.

While it has been described that a cutter can be used to make the bit, other suitable processes can be used instead, such as extrusion or any other acceptable process.

Regardless of the exact configuration and dimensions of the fastening system itself, an embodiment of the present invention provides lines of contact between the two components, as opposed to mere points of contact, and this provides several benefits, some of which have been described herein. Thus, lines of contact between two components may include but are not limited to: external drive systems, i.e., stems, heads, sockets; combinations of internal or external variations; equal or unequal lobe widths; symmetric or asymmetric configurations; and inverse versions of the component geometries disclosed herein.

Several trademark registrations for the trademarks TORX® and TORX PLUS®, both in the United States and abroad, are owned by Acument Intellectual Properties, LLC, the assignee of the present application. Since its invention, the TORX PLUS® brand drive system has consistently outperformed every other drive system on the market. Its longer tool life and optimal torque transfer have enhanced product reliability, increased productivity, and reduced total assembly costs on assembly lines in a multitude of industries around the world. The TORX PLUS® brand drive system has an elliptically-based geometry, a Zero degree drive angle, six lobes with large cross-sectional area, vertical sidewalls and reduced recess fallaway, and greatly increased strength and reliability. The TORX PLUS® brand drive system is also compatible with the drive tools of its predecessor, the TORX® brand drive system. In contrast to the TORX PLUS® brand drive system, the TORX® brand drive system has a cylindrically based geometry. The TORX® brand drive system is described and illustrated in U.S. Pat. No. 3,584,667 and the TORX PLUS® brand drive system is described and illustrated in U.S. Pat. Nos. 5,207,132 and 5,279,190. These three United States patents are hereby incorporated by reference in their entireties. The present invention can be used in connection with any existing multi-lobular drive systems, such as those which are disclosed in these three patents as well as that which are disclosed in United States Patent Publication No. 20180003241 (relating to U.S. patent application Ser. No. 15/704,887), which is also hereby incorporated by reference in its entirety.

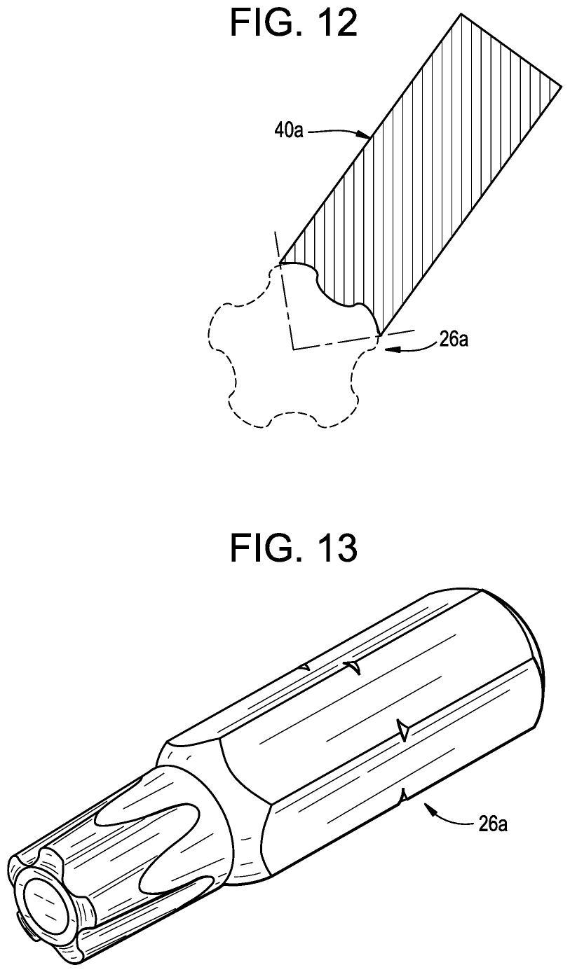

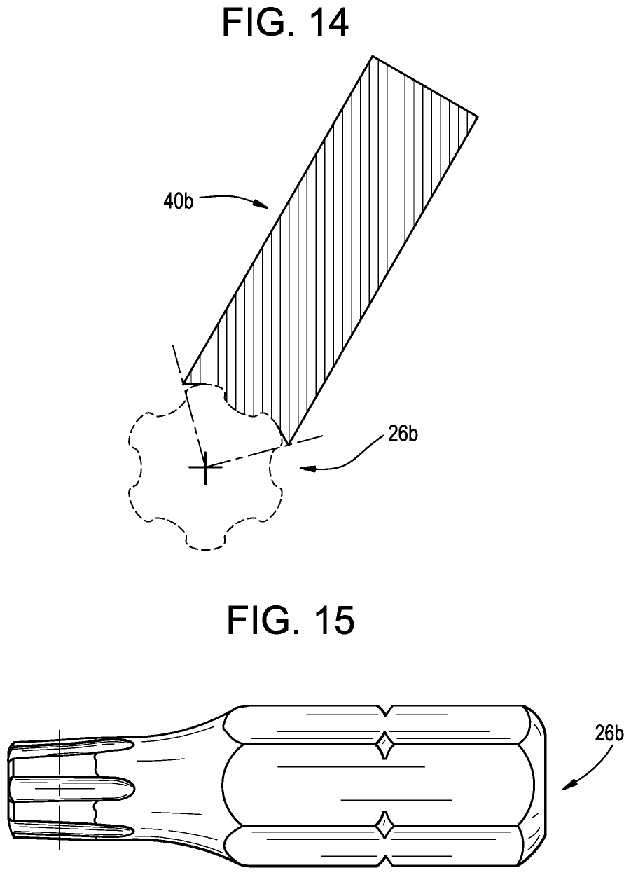

While a six lobe drive system is shown in FIGS. 3-5, a different number of lobes can be provided while still staying within the scope of the present invention. For example, the present invention can be employed in connection with a five lobe, tamper-resistant drive system. FIG. 12 shows a cutter 40a being used to form a bit 26a having 5-lobe tamper-resistant profile, while FIG. 13 shows the bit 26a after it has been made. As shown in FIG. 13, the bit may have an opening at the end which is configured to receive a post in the middle of a recess.

In one example of such an amendment, with regard to the profile of the bit 26a, assuming the A dimension is approximately 0.111100 inches, the B dimension is preferably 0.08020 inches, the Fa dimension is 0.00770 inches, the Fb dimension is 0.01533 inches, the Ea dimension is 0.00770 inches, the Eb dimension is 0.01533 inches, the S dimension is 0.04780 inches, and the P dimension is 0.04780 inches. Another example would provide that the A dimension is approximately 0.070000 inches, the B dimension is 0.50680 inches, the Fa dimension is 0.04880 inches, the Fb dimension is 0.09710 inches, the Ea dimension is 0.04780 inches, the Eb dimension is 0.09610 inches, the S dimension is 0.30120 inches, and the P dimension is 0.30120 inches.

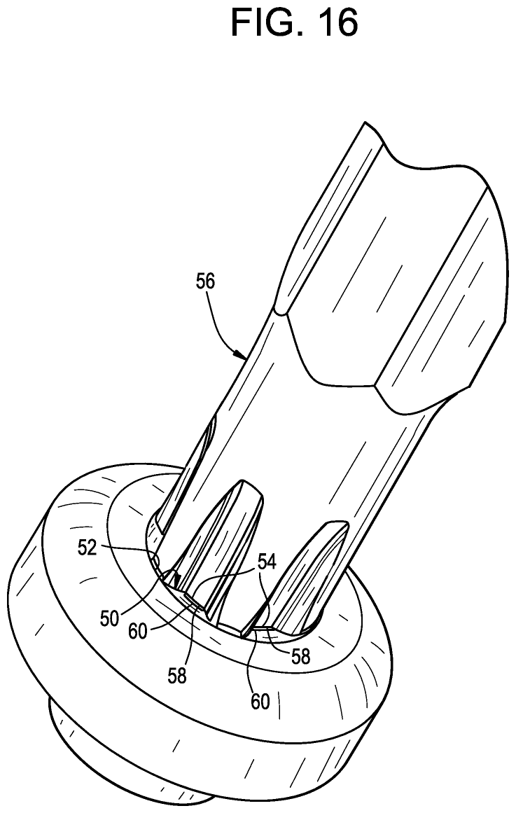

As mentioned, the present invention can be used in connection with existing multi-lobular drive systems such as that which is disclosed in U.S. Pat. No. 5,207,132. FIG. 14 shows a cutter 40b being used to form a miniature, tamper-resistant bit 26b that is made in accordance with the '132 patent, while FIG. 14 shows the bit 26b after it has been made.

In one example of such an amendment, with regard to the profile of the bit 26b, assuming the A dimension is approximately 0.05800 inches, the B dimension is preferably 0.04320 inches, the Fa dimension is 0.00370 inches, the Fb dimension is 0.00669 inches, the Ea dimension is 0.00370 inches, the Eb dimension is 0.00669 inches, the S dimension is 0.02539 inches, and the P dimension is 0.02539 inches. Another example would provide that the A dimension is approximately 0.09420 inches, the B dimension is 0.07220 inches, the Fa dimension is 0.00550 inches, the Fb dimension is 0.01101 inches, the Ea dimension is 0.00550 inches, the Eb dimension is 0.01101 inches, the S dimension is 0.04160 inches, and the P dimension is 0.04160 inches.

With regard to any and all embodiments regarding a bit, preferably a gage is provided for testing the profile of the bit wherein the gage is configured to receive the end of the bit wherein the bit is inserted squarely into the gage until the bit stops. At that point, the gage will indicate the depth of insertion which must be at least a certain value for the bit to pass the test. For example, with regard to a bit which has an A dimension which is approximately 0.05800 inches, preferably the depth of insertion into the gage would be between 0.014 and 0.019 inches.

Regardless, of the exact number of lobes, or whether a bit is provided as being tamper-resistant, preferably a bit cutter is used to form a profile on a bit where the bit cutter matches the configuration of a recess in a corresponding fastener with which the bit is configured to engage. The bit cutter profile preferably progresses along a taper, and the bit which is ultimately formed is configured to contact the top of the recess in the fastener, along a plurality of lines of contact (i.e., along both the lobes and the flutes of the recess of the fastener). The fact that a plurality of lines of contact result provides for improved frictional adhesion or “stick fit” between the bit and the fastener, compared to prior art configurations that provide only points of contact between the two components. Providing lines of contact enables achieving a satisfactory stick fit, despite the size of the bit. While the drawings show the lines of contact at certain locations about the recess, the fastening system may be configured to instead provide the lines of contact at other areas.

While specific embodiments of the invention have been shown and described, it is envisioned that those skilled in the art may devise various modifications without departing from the spirit and scope of the present invention.

What is claimed is:

1. A fastener system comprising:
a fastener comprising a head, wherein a recess is provided in the head and comprises a configuration, wherein the recess comprises a top; and
a bit configured to contact the top of the recess along a plurality of lines of contact along both the lobes and the flutes of the recess of the fastener, wherein the plurality of lines of contact provides for frictional adhesion between the bit and the fastener.

2. A fastener system as recited in claim 1, further comprising a bit cutter which matches the configuration of the recess in the fastener, wherein the bit cutter comprises a taper and a profile, wherein the profile progresses along the taper.

3. A fastener system as recited in claim 1, wherein the recess of the fastener comprises lobes and flutes.

4. A fastener system as recited in claim 3, wherein the bit is configured to contact the top of the recess along the plurality of lines of contact along both the lobes and the flutes of the recess of the fastener.

5. A fastener system as recited in claim 1, wherein each line of contact is curvilinear.

6. A fastener system as recited in claim 3, wherein each line of contact extends not only across an end of one of the lobes but also across and along a side of said one of the lobes going toward adjacent flutes.

7. A fastener system as recited in claim 3, wherein the flutes of the recess are deeper than the lobes.

8. A fastener system as recited in claim 1, wherein the recess of the fastener comprises six lobes and six flutes.

9. A fastener system as recited in claim 1, wherein the recess of the fastener comprises five lobes, five flutes and is configured to provide tamper-resistance.

10. A fastener system as recited in claim 1, wherein the recess of the fastener has a middle, and comprises a post at the middle of the recess which is configured to provide tamper-resistance.

11. A fastener system as recited in claim 9, wherein the bit comprises an end having an opening, wherein the opening is configured to receive the post in the middle of the recess when the bit is engaged in the recess of the fastener.

12. A fastener system as recited in claim 1, wherein the plurality of lines of contact between the bit and the fastener provides for frictional adhesion between the bit and the fastener.

13. A fastener system as recited in claim 2, wherein a cross-sectional configuration diameter of the bit changes along a tapered cutter path.

14. A fastener system as recited in claim 1, wherein the recess of the fastener comprises lobes and flutes, wherein the bit is configured to contact the top of the recess along the plurality of lines of contact along both the lobes and the flutes of the recess of the fastener, wherein each line of contact is curvilinear, and wherein each line of contact extends not only across an end of one of the lobes but also across and along a side of said one of the lobes going toward adjacent flutes.
